(19) United States
(12) Patent Application Publication
(10) Pub. No.: US 2014/0182701 A1
(43) Pub. Date: Jul. 3, 2014

(54) LIQUID TRANSFERRING APPARATUS

(71) Applicant: KOMORI CORPORATION, Tokyo (JP)

(72) Inventor: Ikuo SUGIMOTO, Tsukuba-shi (JP)

(73) Assignee: KOMORI CORPORATION, Tokyo (JP)

(21) Appl. No.: 14/139,443

(22) Filed: Dec. 23, 2013

(30) Foreign Application Priority Data
Dec. 28, 2012 (JP) 2012-286887

(51) Int. Cl. F17D 3/01

(52) U.S. Cl. CPC F17D 3/01
USPC 137/82

(57) ABSTRACT

In a coating apparatus including: an anilox roller which is rotatably supported and in which multiple recessed cells are formed on an outer peripheral surface; and a chamber device which is in contact with the outer peripheral surface of the anilox roller and in which varnish to be coated on a sheet is delivered from a delivery path of a chamber head into a chamber, the chamber device configured to supply the delivered varnish from the chamber to the cells of the anilox roller and discharge the varnish in the chamber from a discharge hole of a chamber body to the outside, the chamber device has pressure fluctuation reducing means, in an attachment hole of the chamber body, for reducing a pressure fluctuation in the chamber of the chamber head in such a way that the pressure in the chamber is maintained constant.

### TECHNICAL FIELD

The present invention relates to a liquid transferring apparatus configured to transfer a liquid to a target object, and is particularly effective when applied to a coating apparatus for coating a sheet with varnish.

### BACKGROUND ART

For example, a coating apparatus for coating a sheet with varnish for coating the sheet with the varnish from a blanket cylinder (transfer) by supplying the varnish from a doctor chamber to an anilox roller in which many recessed cells are formed on an outer peripheral surface, and transferring the varnish supplied into the cells of the anilox roller to an outer peripheral surface of the blanket cylinder.

Such a coating apparatus may have the following problem. When the varnish in the cells of the anilox roller is transferred to the blanket cylinder and the cells become empty, the cells carry air into the doctor chamber thereby generating air bubbles in the varnish in the doctor chamber. This causes variations in amounts of the varnish to be newly supplied to the cells of the anilox roller and hinders uniform coating.

In view of this, for example, Patent Document 1 listed below and the like propose an apparatus in which pressure sensor configured to measure an internal pressure is provided in the doctor chamber, and a control device performs feedback control of ejection pressures of a delivery pump and a return pump on the basis of information from the pressure sensor in such a way that the inside of the doctor chamber is maintained at a constant pressure higher than that of the outside, the delivery pump configured to deliver the varnish from a tank storing the varnish to the doctor chamber, the return pump configured to return the varnish in the doctor chamber to the tank. This apparatus thereby hinders air in the empty cells of the anilox roller from entering the doctor chamber.

### CITATION LIST

### Patent Literature

### Patent Literature 1

U.S. Pat. No. 6,379,463

### SUMMARY OF INVENTION

### Technical Problem

However, in the apparatus described in Patent Literature 1 and the like, since the control device performs the feedback control of the pumps on the basis of the information from the pressure sensor to maintain the inside of the doctor chamber at the constant pressure higher than that of the outside, the apparatus has a complicated configuration and is high in cost.

Such problems may occur not only in the coating apparatus for coating the sheet with the varnish, but also in, as a matter of course, a coating apparatus for coating a web with the varnish and any liquid transferring apparatus including: an anilox roller which is rotatably supported and in which multiple recessed cells are formed on an outer peripheral surface; and a chamber device which is in contact with the outer peripheral surface of the anilox roller and in which a liquid to be transferred to a target object is delivered from a delivery path into a chamber, the chamber device configured to supply the liquid from the chamber to the cells of the anilox roller and discharge the liquid in the chamber which is left untransferred to the target object, from a discharge path to the outside.

In view of such problems, an object of the present invention is to provide a liquid transferring apparatus which can uniformly transfer a liquid to a target object in a simple structure at a low cost.

### Solution to Problem

A liquid transferring apparatus of the present invention for solving the problems described above provides a liquid transferring apparatus including: an anilox roller which is rotatably supported and in which a plurality of recessed cells are formed on an outer peripheral surface; and a chamber device which is in contact with the outer peripheral surface of the anilox roller and in which a liquid to be transferred to a target object is delivered from a delivery path into a chamber, the chamber device configured to supply the delivered liquid from the chamber to the cells of the anilox roller and discharge the liquid in the chamber which is left untransferred to the target object, from a discharge path to the outside, the liquid transferring apparatus characterized in that the chamber device has pressure fluctuation reducing means, in the discharge path, for reducing a pressure fluctuation in the chamber in such a way that the pressure in the chamber is maintained constant, the pressure fluctuation reducing means includes discharge path area adjusting means for changing an area of flow through the discharge path in such a way that a flow rate of the liquid to be discharged from the discharge path of the chamber device to the outside is increased and decreased in response to the pressure fluctuation in the chamber of the chamber device, and the discharge path area adjusting means includes: a plug member disposed in the discharge path to be capable of advancing and retreating in such a way as to move in a retreating direction in the discharge path upon receiving a flow pressure of the liquid flowing in the discharge path of the chamber device, the plug member configured to decrease the area of flow through the discharge path as moving in an advancing direction in the discharge path and increase the area of flow through the discharge path as moving in the retreating direction in the discharge path; and biasing means for biasing the plug member in the advancing direction.

Moreover, the liquid transferring apparatus of the present invention is characterized in that, in the liquid transferring apparatus described above, the plug member of the discharge path area adjusting means increases and decreases the area of flow through the discharge path in a direction orthogonal to a flow direction of the liquid, as retreating and advancing in the discharge path of the chamber device.

Furthermore, the liquid transferring apparatus of the present invention is characterized in that, in the liquid transferring apparatus described above, the discharge path area adjusting means includes biasing force adjusting means for adjusting a biasing force of the biasing means.

### Advantageous Effects of Invention

In the liquid transferring apparatus of the present invention, since the chamber device has, in the discharge path, the pressure fluctuation reducing means for reducing the pressure fluctuation in the chamber in such a way that the pressure in the chamber is maintained constant, it is possible to easily maintain the pressure in the chamber of the chamber device at a constant pressure value higher than that of the outside and uniformly transfer the liquid to the target object in a simple structure at a low cost.

### BRIEF DESCRIPTION OF DRAWINGS

FIG. 1 is a schematic configuration diagram of a main portion of a main embodiment of a case where a liquid transferring apparatus of the present invention is applied to a coating apparatus.

FIG. 2 is an extracted enlarged cross-sectional view of a main portion of FIG. 1.

FIG. 3 is a cross-sectional view taken along the line of FIG. 2 as viewed in the direction of the arrows.

### DESCRIPTION OF EMBODIMENTS

An embodiment of a liquid transferring apparatus of the present invention is described based on the drawings. Note that the liquid transferring apparatus of the present invention is not limited to the embodiment described below based on the drawings.

### Main Embodiment

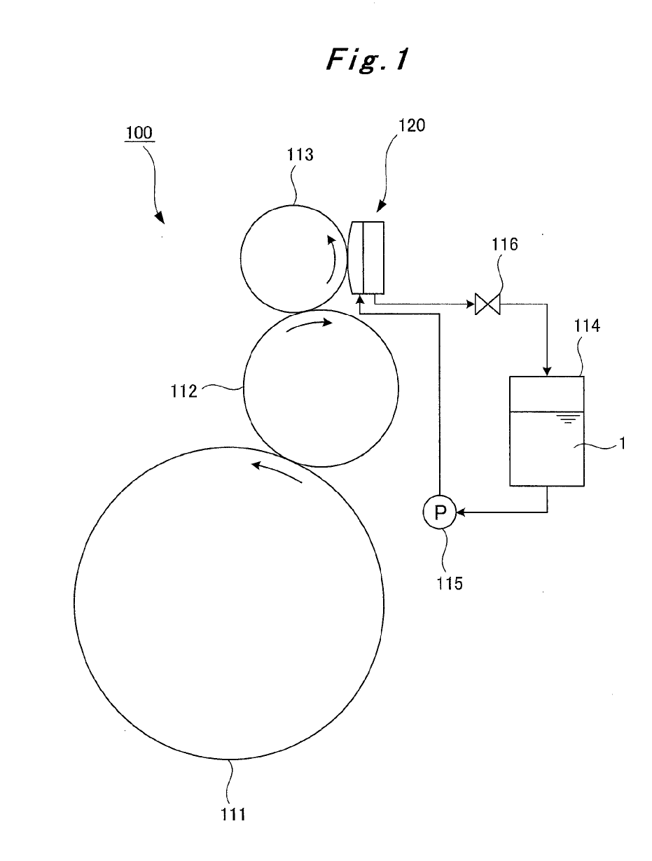

A main embodiment of a case where the liquid transferring apparatus of the present invention is applied to a coating apparatus is described below based on FIGS. 1 to 3.

As shown in FIG. 1, a blanket cylinder 112 rotatably supported and provided with a rubber blanket on an outer periphery is in contact with an impression cylinder 111 rotatably supported and configured to hold a sheet on an outer peripheral surface, the sheet being a target object and held detachably and attachably.

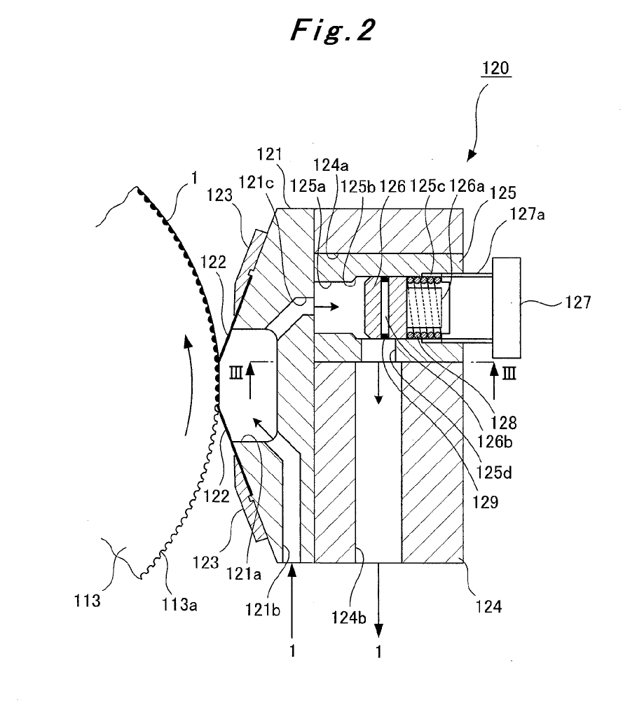

As shown in FIGS. 1 and 2, an anilox roller 113 which is rotatably supported and in which multiple recessed cells 113a arc formed on an outer peripheral surface is in contact with the blanket cylinder 112. A chamber device 120 configured to supply varnish 1, which is a liquid, to the cells 113a of the anilox roller 113 is in contact with the outer peripheral surface of the anilox roller 113. The chamber device 120 has the structure described below.

A chamber head 121 is disposed on a side facing the anilox roller 113 and a chamber 121a configured to eject the varnish 1 is formed on a side of the chamber head 121 which faces the anilox roller 113, to extend along an axial direction of the anilox roller 113.

Doctor blades 122 which are made of a high polymer material or stainless-steel and whose longitudinal directions extend along the axial direction of the anilox roller 113 are disposed in an opening portion of the chamber 121a of the chamber head 121 in such a way that front end sides thereof are in contact with the outer peripheral surface of the anilox roller 113. The doctor blades 122 are provided to be paired and to be symmetric to each other with respect to a plane passing through the axis center of the anilox roller 113, and are detachably attached to the chamber head 121 with fasteners 123.

In other words, the chamber 121a of the chamber head 121 can guide the varnish 1 from a gap between the paired doctor blades 122 and supply the varnish 1 into the cells 113a of the anilox roller 113.

In the chamber head 121, there are formed a delivery hole 121b which is a delivery path for delivering the varnish 1 to an inside of the chamber 121a and a discharge hole 121c for discharging the varnish 1 from the inside of the chamber 121a. A surface of the chamber head 121 on the opposite side)right side in FIG. 2) to a surface on the side (left side in FIG. 2) facing the anilox roller 113 is attached to a chamber body 124.

In the chamber body 124, there are formed: an attachment hole 124a which penetrates the chamber body 124 to extend between a surface on the side (left side in FIG. 2) facing the anilox roller 113 and a surface on the opposite side (right side in FIG. 2) to the surface on the side facing the anilox roller 113 and which communicates with the discharge hole 121c of the chamber head 121; and a discharge hole 124b whose axial direction extends in a direction (up-down direction in FIG. 2) intersecting (orthogonal to) an axial direction (left-right direction in FIG. 2) of the attachment hole 124a in such a way that the attachment hole 124a and the outside communicate with each other.

A cylindrical attachment member 125 having a connection hole 125a connected to the discharge hole 121c of the chamber head 121 is fitted to the attachment hole 124a of the chamber body 124. In the connection hole 125a of the attachment member 125, a step portion 125b whose diameter becomes smaller in size toward the chamber head 121 (to the left in FIG. 2) is formed in an inner peripheral surface close to the chamber head 121 (left side in FIG. 2) and a female thread portion 125c is formed in the inner peripheral surface on the opposite side (right side in FIG. 2) to the chamber head 121 side (left side in FIG. 2).

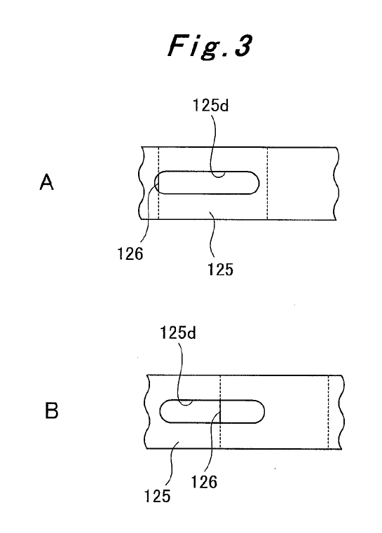

A communication hole 125d through which the connection hole 125a and the discharge hole 124b of the chamber body 124 communicate with each other is formed in a middle portion of the attachment member 125 in an axial direction thereof. As shown in FIG. 3, the communication hole 125d has an elongated shape whose longitudinal direction extends along an axial direction of the connection hole 125a (left-right direction in FIG. 3).

A plunger 126 which is a plug member is provided in a middle portion of the connection hole 125a of the attachment member 125 in the axial direction thereof in such away as to be movable by sliding along the axial direction (left-right direction in FIG. 2). A male thread portion 127a of an adjustment screw 127 which is biasing force adjusting means is screwed to the female thread portion 125c of the connection hole 125a of the attachment member 125.

A compression coil spring 128 which is biasing means is interposed between the plunger 126 in the connection hole 125a of the attachment member 125 and the male thread portion 127a of the adjustment screw 127. A guide rod 126a configured to guide expansion and contraction of the compression coil spring 128 is provided coaxially on the adjustment screw 127 side (right side in FIG. 2) of the plunger 126.

The adjustment screw 127 can be used to adjust the biasing force of the compression coil spring 128 against the plunger 126 by adjusting a position where the adjustment screw 127 is screwed to the female thread portion 125c of the attachment member 125. Moreover, the plunger 126 is biased by the biasing force of the compression coil spring 128 in such a way that a front end side (left side in FIG. 2) of the plunger 126 comes in contact with the step portion 125b of the connection hole 125a of the attachment member 125. Meanwhile, the plunger 126 moves to a position on the female thread portion 125c side (right side in FIG. 2), against the biasing force of the compression coil spring 128, upon receiving a pressure (flow rate) of the varnish 1 flowing from the discharge hole 121c of the chamber head 121 into the connection hole 125a of the attachment member 125. This can change an opening area of the communication hole 125d communicating with the connection hole 125a (see FIG. 3).

Note that reference numeral 129 in FIG. 2 is an O-ring fitted to a groove 126b formed in an outer peripheral surface of the plunger 126.

As shown in FIGS. 1 and 2, a delivery port of a delivery pump 115 configured to deliver the varnish 1 is connected to the delivery hole 121b of the chamber head 121. A receiving port of the delivery pump 115 is connected to a storage tank 114 configured to store the varnish 1. Moreover, the discharge hole 124b of the chamber body 124 is connected to the storage tank 114 via a pressure adjusting valve 116.

In the embodiment described above, a discharge path of the chamber device 120 is formed of the discharge hole 121c of the chamber head 121 and the discharge hole 124b of the chamber body 124 as well as the connection hole 125a and the communication hole 125d of the attachment member 125. Discharge path area adjusting means is formed of the attachment member 125, the plunger 126, the adjustment screw 127, the compression coil spring 128, the O-ring, and the like. Pressure fluctuation reducing means is formed of the discharge path area adjusting means and the like.

Next, an action of the aforementioned coating apparatus 100 of the embodiment is described.

When the cylinders 111 and 112 and the anilox roller 113 are rotated and the delivery pump 115 is activated, the varnish 1 in the storage tank 114 is delivered from the delivery hole 121b of the chamber head 121 of the chamber device 120 into the chamber 121a at a pressure higher than that of the outside, supplied into the cells 113a of the anilox roller 113, transferred to the blanket of the blanket cylinder 112, and transferred to the sheet held on the outer peripheral surface of the impression cylinder 111 to coat the sheet.

In this case, since the pressure in the chamber 121a of the chamber head 121 of the chamber device 120 is higher than that of the outside, it is possible to significantly suppress entry of air into the chamber 121a of the chamber head 121, the entry caused by the empty cells 113a of the anilox roller 113 from which the varnish 1 has been transferred to the blanket of the blanket cylinder 112. Moreover, even if air should enter the chamber 121a of the chamber head 121, air bubbles can be pushed out from the inside of the chamber 121a. Accordingly, it is possible to evenly supply the varnish 1 into the cells 113a of the anilox roller 113 and uniformly coat the sheet with the varnish 1 via the blanket cylinder 112.

Meanwhile, when the varnish 1 not supplied into the cells 113a of the anilox roller 113 and remaining in the chamber 121a of the chamber head 121 to be left untransferred to the sheet flows from the discharge hole 121c of the chamber head 121 into the connection hole 125a of the attachment member 125, the plunger 126 receives a flow pressure (flow rate) corresponding to the flow rate of the varnish 1 and is thereby pushed back (retreat movement) against the biasing force of the compression coil spring 128 in response to the flow pressure (flow rate). As a result, the communication hole 125d is opened in such a way that the opening area thereof corresponds to the flow pressure (flow rate) of the varnish 1.

The varnish 1 thereby flows from the communication hole 125d into the discharge hole 124b of the chamber body 124 at a flow rate corresponding to the flow pressure (flow rate), and is returned to the storage tank 114 via the pressure adjusting valve 116 to be circulated and reused.

In the coating of the sheet with the varnish 1 as described above, when the viscosity of the varnish 1 decreases due to, for example, temperature change or the like, the amount of the varnish 1 delivered to the chamber device 120 by the delivery pump 115 increases, i.e. the flow pressure of the varnish 1 increases. In this case, the amount of the varnish 1 not supplied into the cells 113a of the anilox roller 113 and remaining in the chamber 121a of the chamber head 121 to be left untransferred to the sheet increases and the flow rate of the varnish 1 from the discharge hole 121c of the chamber head 121 into the connection hole 125a of the attachment member 125 increases.

This causes the flow pressure (flow rate) which the plunger 126 receives from the varnish 1 to increase. Accordingly, an opposing force against the compression coil spring 128 further increases and the plunger 126 is further pushed back (retreat movement) against the biasing force of the compression coil spring 128. As a result, the opening area of the communication hole 125d is increased corresponding to the flow pressure (flow rate) of the varnish 1.

The varnish 1 thereby flows from the communication hole 125d into the discharge hole 124b of the chamber body 124 at a flow rate corresponding to the flow pressure (flow rate), and is returned to the storage tank 114 via the pressure adjusting valve 116. Accordingly, in the chamber 121a of the chamber head 121, the pressure fluctuation is reduced and the pressure is maintained constant.

Meanwhile, when the viscosity of the varnish 1 increases due to, for example, temperature change or the like, the amount of the varnish 1 delivered to the chamber device 120 by the delivery pump 115 decreases, i.e. the flow pressure of the varnish 1 decreases. In this case, the amount of the varnish 1 not supplied into the cells 113d of the anilox roller 113 and remaining in the chamber 121a of the chamber head 121 to be left untransferred to the sheet decreases and the flow rate of the varnish 1 from the discharge hole 121c of the chamber head 121 into the connection hole 125a of the attachment member 125 decreases.

This causes the flow pressure (flow rate) which the plunger 126 receives from the varnish 1 to decrease. Accordingly, the opposing force against the compression coil spring 128 decreases and the plunger 126 is pushed forward (advancing movement) by the biasing force of the compression coil spring 128. As a result, the opening area of the communication hole 125d is decreased corresponding to the flow pressure (flow rate) of the varnish 1.

The varnish 1 thereby flows from the communication hole 125d into the discharge hole 124b of the chamber body 124 at a flow rate corresponding to the flow pressure (flow rate), and is returned to the storage tank 114 via the pressure adjusting valve 116. Accordingly, in the chamber 121a of the chamber head 121, the pressure fluctuation is reduced and the pressure is maintained constant.

In summary, the plunger 126 is disposed in the connection hole 125a of the attachment member 125 to be capable of advancing and retreating while being biased in the advancing direction (left side in FIG. 2) by the compression coil spring 128, in such a way as to be movable in the retreating direction (right side in FIG. 2) in the connection hole 125a upon receiving the flow pressure of the varnish 1 flowing into the connection hole 125a. The plunger 126 can thereby reduce the area of flow through the communication hole 125d in a direction orthogonal to the flow direction of the varnish 1 as moving in the advancing direction (left side in FIG. 2) in the connection hole 125a and increase the area of flow through the communication hole 125d in the direction orthogonal to the flow direction of the varnish 1 as moving in the retreating direction (right side in FIG. 2) in the connection hole 125a. In other words, the opening area of the communication hole 125d of the attachment member 125 can be changed in such a way that the flow rate of the varnish 1 discharged from the discharge hole 124b of the chamber body 124 to the outside is increased and decreased in response to the pressure fluctuation in the chamber 121a of the chamber head 121.

The chamber device 120 can thus greatly reduce the pressure fluctuation in the chamber 121a of the chamber head 121 in such a way that the pressure in the chamber 121a is maintained constant.

Accordingly, in the coating apparatus 100 of the embodiment, it is possible to easily maintain the pressure in the chamber 121a of the chamber head 121 at a constant pressure value higher than that of the outside and uniformly coat the sheet with the varnish (transfer) in a simple structure at a low cost.

Moreover, in a case where a diaphragm pump is used as the delivery pump 115, it is possible to omit a damper which is otherwise required to be provided between the delivery port of the pump 115 and the delivery hole 121b of the chamber head 121 of the chamber device 120 to reduce pulsation occurring in the delivery of the varnish 1.

### Other Embodiments

In the embodiment described above, the compression coil spring 128 is used as the biasing means and the adjustment screw 127 is used as the biasing force adjusting means. However, as another embodiment, a cylinder which is filled with air and in which a plug member is inserted can be used as the biasing means instead of the compression coil spring 128 and a pressure adjusting valve provided in the cylinder can be used as the biasing force adjusting means instead of the adjustment screw 127.

Moreover, in the embodiment described above, a description is given of the case where the present invention is applied to the coating apparatus 100 for coating the sheet with the varnish. However, the present invention is not limited to this application and can be applied to, as a matter of course, a coating apparatus for coating a web with the varnish and to any liquid transferring apparatus including: an anilox roller which is rotatably supported and in which multiple recessed cells are formed on an outer peripheral surface; and a chamber device which is in contact with the outer peripheral surface of the anilox roller and in which a liquid to be transferred to a target object is delivered from a delivery path into a chamber, the chamber device configured to supply the liquid from the chamber to the cells of the anilox roller and discharge the liquid in the chamber which is left untransferred to the target object, from a discharge path to the outside. Operations and effects similar to those of the embodiment described above can be obtained also in such a liquid transferring apparatus.

### INDUSTRIAL APPLICABILITY

In the liquid transferring apparatus of the present invention, it is possible to easily maintain the pressure in the chamber of the chamber device at a constant pressure value higher than that of the outside and uniformly transfer the liquid to the target object in a simple structure at a low cost. Accordingly, the present invention can be highly useful in the printing industry and other industries when applied to, for example, a coating apparatus for coating a sheet with varnish.

### REFERENCE SIGNAL LIST

1 VARNISH

100 COATING APPARATUS

111 IMPRESSION CYLINDER

112 BLANKET CYLINDER

113 ANILOX ROLLER

113a CELL

114 STORAGE TANK

115 DELIVERY PUMP

116 PRESSURE ADJUSTING VALVE

120 CHAMBER DEVICE

121 CHAMBER HEAD

121a CHAMBER

121b DELIVERY HOLE

121c DISCHARGE HOLE

122 DOCTOR BLADE

123 FASTENER

124 CHAMBER BODY

124a ATTACHMENT HOLE

124b DISCHARGE HOLE

125 ATTACHMENT MEMBER

125a CONNECTION HOLE

125b STEP PORTION

125c FEMALE THREAD PORTION

125d COMMUNICATION HOLE

126 PLUNGER

126a GUIDE ROD

126b GROOVE

127 ADJUSTMENT SCREW

127a MALE THREAD PORTION

128 COMPRESSION COIL SPRING

129 O-RING

1. A liquid transferring apparatus comprising:
an anilox roller which is rotatably supported and in which a plurality of recessed cells are formed on an outer peripheral surface; and
a chamber device which is in contact with the outer peripheral surface of the anilox roller and in which a liquid to be transferred to a target object is delivered from a delivery path into a chamber, the chamber device configured to supply the delivered liquid from the chamber to the cells of the anilox roller and discharge the liquid in the chamber which is left untransferred to the target object, from a discharge path to the outside, wherein
the chamber device has pressure fluctuation reducing means, in the discharge path, for reducing a pressure fluctuation in the chamber in such a way that the pressure in the chamber is maintained constant,
the pressure fluctuation reducing means includes discharge path area adjusting means for changing an area of flow through the discharge path in such a way that a flow rate of the liquid to be discharged from the discharge path of the chamber device to the outside is increased and decreased in response to the pressure fluctuation in the chamber of the chamber device, and
the discharge path area adjusting means includes:
a plug member disposed in the discharge path to be capable of advancing and retreating in such a way as to move in a retreating direction in the discharge path upon receiving a flow pressure of the liquid flowing in the discharge path of the chamber device, the plug member configured to decrease the area of flow through the discharge path as moving in an advancing direction in the discharge path and increase the area of flow through the discharge path as moving in the retreating direction in the discharge path; and
biasing means for biasing the plug member in the advancing direction.

2. The liquid transferring apparatus according to claim 1, wherein the plug member of the discharge path area adjusting means increases and decreases the area of flow through the discharge path in a direction orthogonal to a flow direction of the liquid, as retreating and advancing in the discharge path of the chamber device.

3. The liquid transferring apparatus according to claim 1, wherein the discharge path area adjusting means includes biasing force adjusting means for adjusting a biasing force of the biasing means.
